(19) United States
(12) Patent Application Publication
(10) Pub. No.: US 2009/0310683 A1
(43) Pub. Date: Dec. 17, 2009

(54) Video coding device and video coding method

(75) Inventor: Atsushi Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/461,651

(22) Filed: Aug. 19, 2009

Related U.S. Application Data
(63) Continuation of application No. PCT/JP2007/053262, filed on Feb. 22, 2007.

(51) Int. Cl. H04N 7/26

(52) U.S. Cl. 375/240.16; 375/E07.104

(57) ABSTRACT

A video coding device includes an image-dividing number setting unit and a coding unit in the aims of suppressing an occurrence of a load cache miss when decoding a coded data without increasing a capacity of a cache memory even when a resolution of a video is high. The image-dividing number setting unit sets a dividing number of image. The coding unit divides a coding object image constituting the video into partial images with the same number as the dividing number of image, and performs a coding processing using a motion compensation on each of the partial images.

### CROSS-REFERENCE TO RELATED APPLICATION

This application is a Continuation application of International Application No. PCT/JP2007/053262, filed Feb. 22, 2007, designating the U.S., the entire contents of which are incorporated herein by reference.

### FIELD

The embodiment is related to a video coding device and a video coding method complying with a video coding standard.

### BACKGROUND

Recently, high-quality reproduction of video such as a high-definition television (high-resolution, low-noise, high frame rate, and so on) is required in a video reproduction system. When a high-resolution video is reproduced, a large memory capacity and a great number of memory accesses are necessary because it is necessary to process a large amount of data compared to a case when a low-resolution video is reproduced. In a high-resolution video decoding processing, a great number of processing to load reference images is performed when a coded data generated by a coding processing using a motion compensation being one of element technologies of a video coding technology is decoded. The processing to read out the reference images from an external memory leads to a decrease of the frame rate and an increase of power consumption of a video decoding device (processor). There is a method to provide a cache memory in the video decoding device as a method for avoiding this problem.

Incidentally, details of the video coding technology (motion compensation and so on) are described in a written standard such as a “Recommendation ITU-T H.262”, a general book such as a “Point-Illustrative Latest MPEG Textbook” (supervised by Hiroshi Fujiwara, ASCII Publishing), and so on, and therefore, the detailed description thereof is not given here. Besides, details of the cache memory are described in a general book such as a “Computer Organization and Design, Third Edition” (edited by David A. Paterson and John L. Hennessey, Nikkei Business Publications, Inc.), and therefore, the detailed description thereof is not given here.

FIG. 15 illustrates a decoding processing sequence and a state of a cache memory when a coded data in a conventional art is decoded. When the coded data in the conventional art is decoded, at first, a decoding is sequentially performed from a macro block MB at a first column (leftmost) as for a first line (FIG. 15 (1)) of a reference image P. When the decoding of the macro block MB at a last column (rightmost) in the first line of the reference image P is completed, the decoding is sequentially performed from the macro block MB at a first column as for a second line (FIG. 15 (2)) of the reference image P. After that, the macro blocks MB in a third line (FIG. 15 (3)), a fourth line (FIG. 15 (4)), . . . , an n-th line (FIG. 15 (n)) of the reference image P are sequentially decoded similarly.

It is assumed that the capacity of the cache memory is small and a reference image data existing in the cache memory is only the data corresponding to a half-tone dot meshing portion in FIG. 15 when the processing shifts to the decoding of the macro blocks MB in the second line of the reference image P after the decoding of the macro blocks MB in the first line of the reference image P is completed. As a result, a load cache miss may occur because a reference image data in a vicinity of the macro blocks MB in the second line of the reference image P does not exist in the cache memory.

The load cache miss does not occur if the capacity of the cache memory is made large enough relative to the resolution (image size) of the video. However, demerits such as an increase of load latency, increases of power consumption and chip area of the video decoding device (processor) may occur if the capacity of the cache memory is enlarged. Besides, the higher the resolution of the video is, the more it is necessary to enlarge the capacity of the cache memory so as to suppress the occurrence of the load cache miss. For example, when the resolution of the video is an HD size (1920 pixels in a vertical direction×1080 pixels in a horizontal direction), a cache memory with a capacity of approximately 90 Kbyte is necessary.

Further, an art to reduce an overhead time according to an access to a cache memory relating to a still image reproduction processing including a corner turn processing (vertical/horizontal transpose processing) and so on to a synthetic aperture radar (SAR) image is discussed in Japanese Laid-open Patent Publication No. 2001-109880.

As stated above, there have been problems in which demerits such as the increase of the load latency, the increases of the power consumption, and chip area of the video decoding device (processor) may occur if the capacity of the cache memory is enlarged to suppress the occurrence of the load cache miss in the video decoding device.

A proposition of the embodiment is to suppress the occurrence of the load cache miss when the coded data is decoded without increasing the capacity of the cache memory even when the resolution of the video is high.

### SUMMARY

According to an aspect of the embodiment, a video coding device includes an image-dividing number setting unit and a coding unit. The image-dividing number setting unit sets a dividing number of image (an image-dividing number setting operation). The coding unit divides a coding object image constituting a video into partial images with the same number as the dividing number of image, and performs a coding processing using a motion compensation on each of the partial images (a coding operation).

The object and advantages will be realized and attained by means of the elements and combinations particularly pointed out in the claims.

It is to be understood that both the foregoing general description and the following detailed description are exemplary and explanatory and are not restrictive, as claimed.

### BRIEF DESCRIPTION OF THE DRAWINGS

FIG. 1 is a block diagram illustrating a first embodiment;

FIG. 2 is a flowchart illustrating an operation of a video coding device in the first embodiment;

FIG. 3 is a conceptual diagram illustrating a coding processing sequence and a structure of a coded data (when a dividing number of image is two) in the first embodiment;

FIG. 4 is a conceptual diagram illustrating the coding processing sequence and the structure of the coded data (when the dividing number of image is three) in the first embodiment;

FIG. 5 is a flowchart illustrating an example of a coding processing in the first embodiment;

FIG. 6 is a flowchart illustrating another example of the coding processing in the first embodiment;

FIG. 7 is a conceptual diagram illustrating a decoding processing sequence and a state of a cache memory (when the dividing number of image is two) when the coded data in the first embodiment is decoded;

FIG. 8 is a conceptual diagram illustrating the decoding processing sequence and the state of the cache memory (when the dividing number of image is three) when the coded data in the first embodiment is decoded;

FIG. 9 is a block diagram illustrating a second embodiment;

FIG. 10 is a flowchart illustrating an operation of a video coding device in the second embodiment;

FIG. 11 is a block diagram illustrating a third embodiment;

FIG. 12 is a flowchart illustrating an operation of a video coding device in the third embodiment;

FIG. 13 is a block diagram illustrating a fourth embodiment;

FIG. 14 is a flowchart illustrating an operation of a video coding device in the fourth embodiment; and

FIG. 15 is a conceptual diagram illustrating a decoding processing sequence and a state of a cache memory when a coded data in a conventional art is decoded.

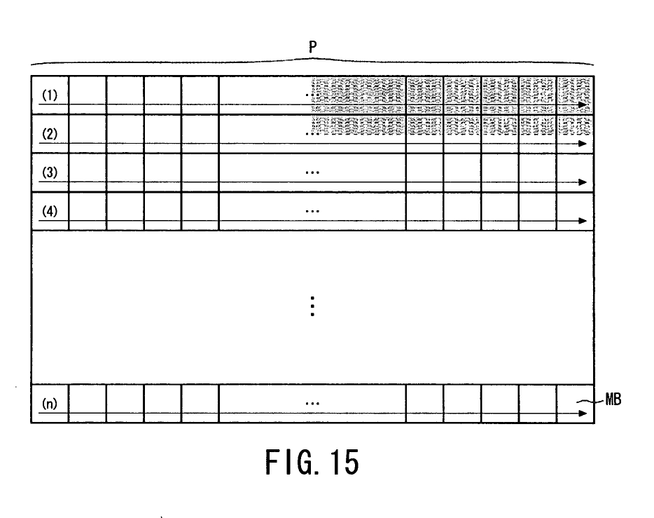

### DESCRIPTION OF THE EMBODIMENTS

Hereinafter, embodiments will be described with reference to the drawings.

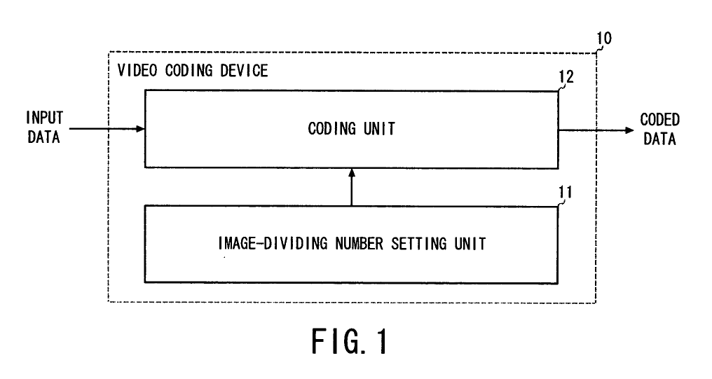

FIG. 1 illustrates a first embodiment. A video coding device 10 of the first embodiment is constituted by including an image-dividing number setting unit 11 and a coding unit 12. For example, the video coding device 10 is embodied by a semiconductor device. The image-dividing number setting unit 11 sets a dividing number of image. The coding unit 12 acquires the dividing number of image held by the image-dividing number setting unit 11, divides a coding object image constituting an input data (video) into partial images with the same number as the dividing number of image, and generates a coded data by performing a coding processing using a motion compensation on each of the partial images.

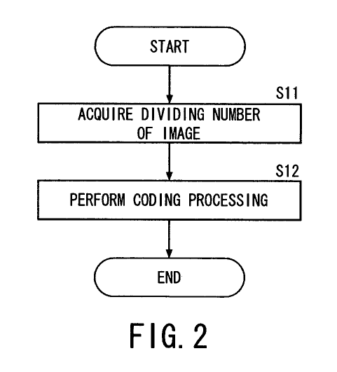

FIG. 2 illustrates an operation of the video coding device in the first embodiment. In the video coding device 10 having the constitution as stated above, the coding unit 12 acquires the dividing number of image held by the image-dividing number setting unit 11 in accordance with a reception of the input data by the video coding device 10 (step S11). The coding unit 12 divides the coding object image into the partial images with the same number as the dividing number of image, and performs the coding processing using the motion compensation on each of the partial images (step S12).

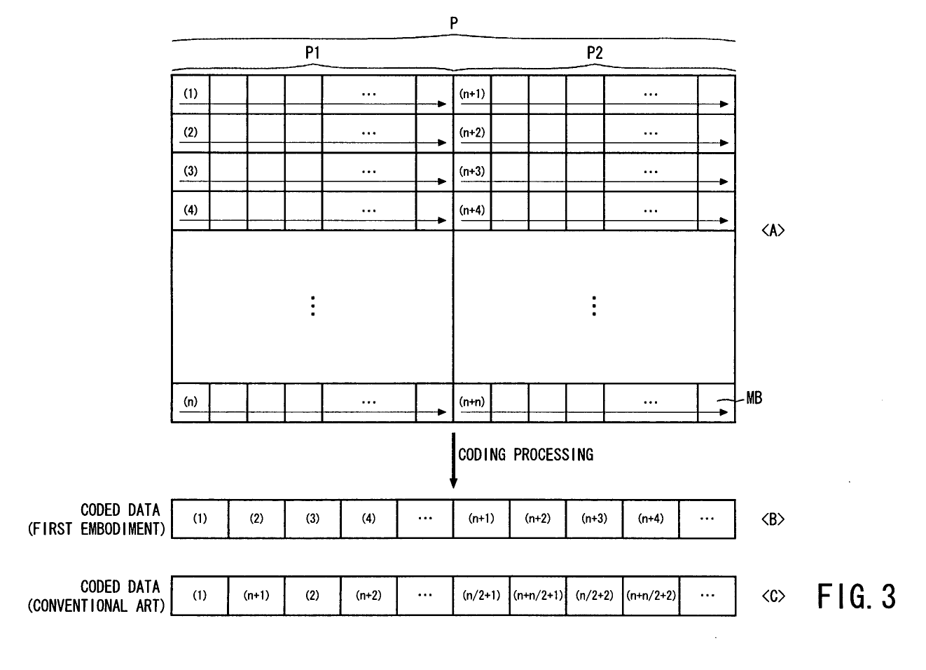

FIG. 3 illustrates a coding processing sequence and a structure of the coded data (when the dividing number of image is two) in the first embodiment. As illustrated in FIG. 3 <A>, a coding object image P is divided into partial images P1 and P2 when the dividing number of image is two, in the coding processing by the coding unit 12. At first, the partial image P1 is selected as an object partial image to be processed, and a coding is sequentially performed from a macro block MB at a first column (leftmost) as for a first line (FIG. 3 (1)) of the partial image P1. When the coding of the macro block MB at a last column (rightmost) in the first line of the partial image P1 is completed, the coding is sequentially performed from the macro block MB at a first column as for a second line (FIG. 3 (2)) of the partial image P1. After that, the macro blocks MB in a third line (FIG. 3 (3)), a fourth line (FIG. 3 (4)), . . . , an n-th line (FIG. 3 (n)) of the partial image P1 are sequentially coded similarly.

When the coding of the macro block MB at a last column in the n-th line of the partial image P1 is completed, the partial image P2 is selected as the object partial image to be processed, and the coding is sequentially performed from the macro block MB at a first column as for a first line (FIG. 3 (n+1)) of the partial image P2. When the coding of the macro block MB at a last column in the first line of the partial image P2 is completed, the coding is sequentially performed from the macro block MB at a first column as for a second line (FIG. 3 (n+2)) of the partial image P2. After that, the macro blocks MB in a third line (FIG. 3 (n+3)), a fourth line (FIG. 3 (n+4)), . . . , an n-th line (FIG. 3 (n+n)) of the partial image P2 are sequentially coded similarly. The coded data generated by the coding processing in the processing sequence as stated above has a structure as illustrated in FIG. 3 <B>. Incidentally, the coded data in a conventional art has a structure as illustrated in FIG. 3 <C>.

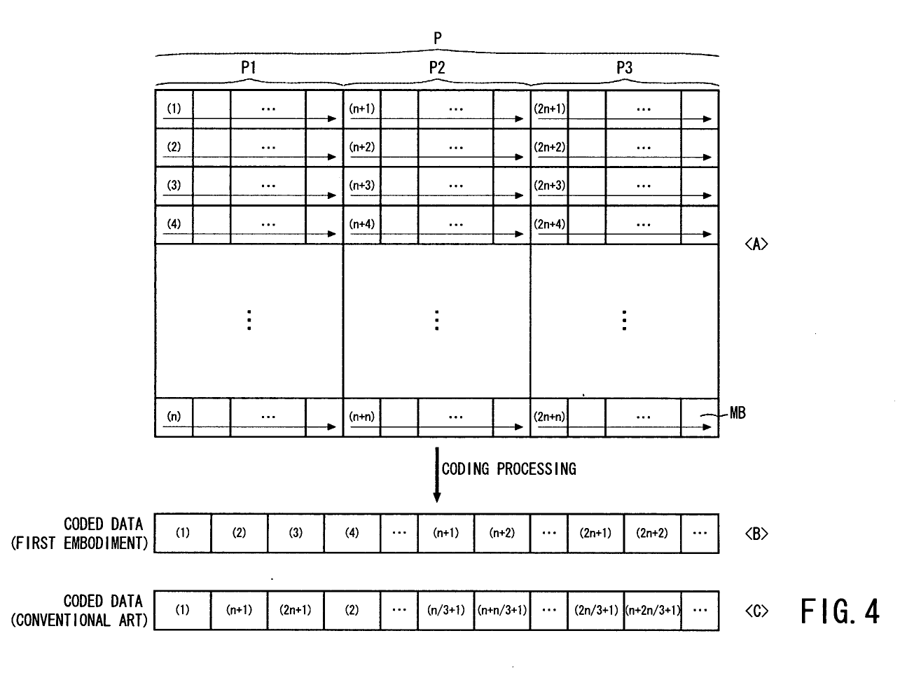

FIG. 4 illustrates the coding processing sequence and the structure of the coded data (when the dividing number of image is three) in the first embodiment. As illustrated in FIG. 4 <A>, the coding object image P is divided into partial images P1, P2, and P3 when the dividing number of image is three, in the coding processing by the coding unit 12. At first, the partial image P1 is selected as the object partial image to be processed, and the coding is sequentially performed from the macro block MB at a first column as for a first line (FIG. 4 (1)) of the partial image P1. When the coding of the macro block MB at a last column in the first line of the partial image P1 is completed, the coding is sequentially performed from the macro block MB at a first column as for a second line (FIG. 4 (2)) of the partial image P1. After that, the macro blocks MB in a third line (FIG. 4 (3)), a fourth line (FIG. 4 (4)), . . . , an n-th line (FIG. 4 (n)) of the partial image P1 are sequentially coded similarly.

When the coding of the macro block MB at a last column in the n-th line of the partial image P1 is completed, the partial image P2 is selected as the object partial image to be processed, and the coding is sequentially performed from the macro block MB at a first column as for a first line (FIG. 4 (n+1)) of the partial image P2. When the coding of the macro block MB at a last column in the first line of the partial image P2 is completed, the coding is sequentially performed from the macro block MB at a first column as for a second line (FIG. 4 (n+2)) of the partial image P2. After that, the macro blocks MB in a third line (FIG. 4 (n+3)), a fourth line (FIG. 4 (n+4)), . . . , an n-th line (FIG. 4 (n+n)) of the partial image P2 are sequentially coded similarly.

When the coding of the macro block MB at a last column in the n-th line of the partial image P2 is completed, the partial image P3 is selected as the object partial image to be processed, and the coding is sequentially performed from the macro block MB at a first column as for a first line (FIG. 4 (2n+1)) of the partial image P3. When the coding of the macro block MB at a last column in the first line of the partial image P3 is completed, the coding is sequentially performed from the macro block MB at a first column as for a second line (FIG. 4 (2n+2)) of the partial image P3. After that, the macro blocks MB in a third line (FIG. 4 (2n+3)), a fourth line (FIG. 4 (2n+4)), . . . , an n-th line (FIG. 4 (2n+n)) of the partial image P3 are sequentially coded similarly. The coded data generated by the coding processing in the processing sequence as stated above has a structure as illustrated in FIG. 4 <B>. Incidentally, the coded data in the conventional art has a structure as illustrated in FIG. 4 <C>.

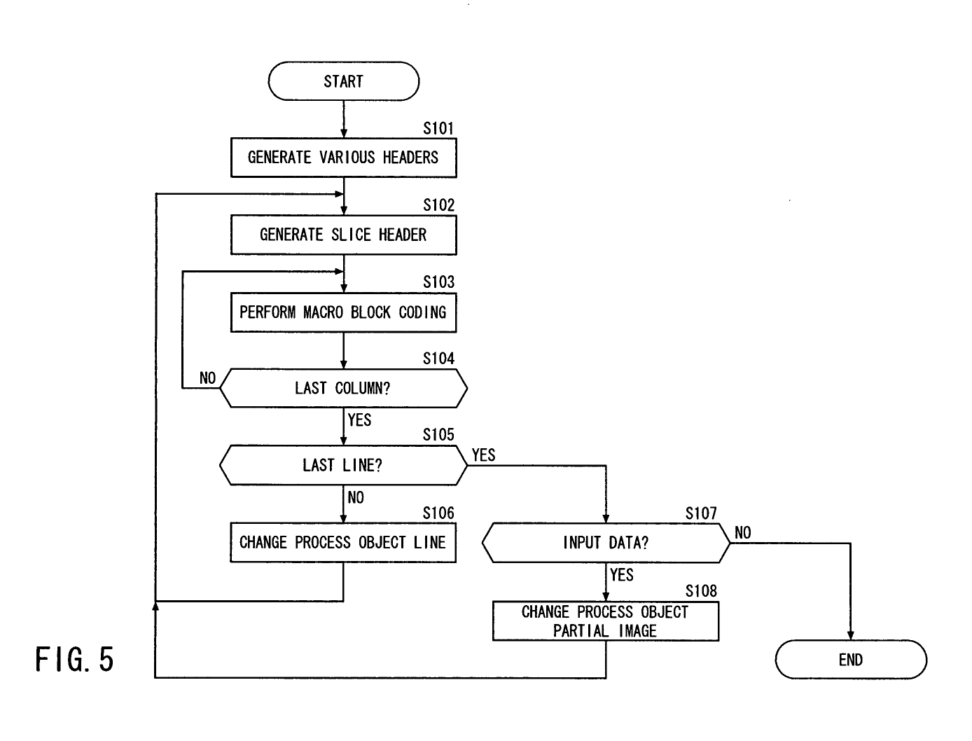

FIG. 5 illustrates an example of the coding processing in the first embodiment. Steps S101 to S108 in FIG. 5 are performed in step S12 in FIG. 2.

In the step S101, the coding unit 12 generates various headers. After that, the coding processing shifts to the step S102.

In the step S102, the coding unit 12 generates a slice header. After that, the coding processing shifts to the step S103.

In the step S103, the coding unit 12 performs the coding of a process object macro block at a process object line of a process object partial image. After that, the coding processing shifts to the step S104.

In the step S104, the coding unit 12 judges whether or not the process object macro block is the macro block at the last column in the process object partial image. When the process object macro block is not the macro block at the last column in the process object partial image, the coding processing shifts to the step S103 again to perform the coding of the macro block at the next column in the process object line of the process object partial image. On the other hand, when the process object macro block is the macro block at the last column in the process object partial image, the coding processing shifts to the step S105.

In the step S105, the coding unit 12 judges whether or not the process object macro block is the macro block in the last line in the process object partial image. When the process object macro block is not the macro block in the last line in the process object partial image, the coding processing shifts to the step S106. On the other hand, when the process object macro block is the macro block in the last line in the process object partial image, the coding processing shifts to the step S107.

In the step S106, the coding unit 12 changes the process object line to the next line in the process object partial image. After that, the coding processing shifts to the step S102 again.

In the step S107, the coding unit 12 judges whether or not there is an input data which is not read out from a receive buffer which temporary stores the input data. When there is the input data which is not read out from the receive buffer, the coding processing shifts to the step S108. On the other hand, when there is not the input data which is not read out from the receive buffer, the coding processing is completed.

In the step S108, the coding unit 12 changes the process object partial image to the next partial image. After that, the coding processing shifts to the step S102 again.

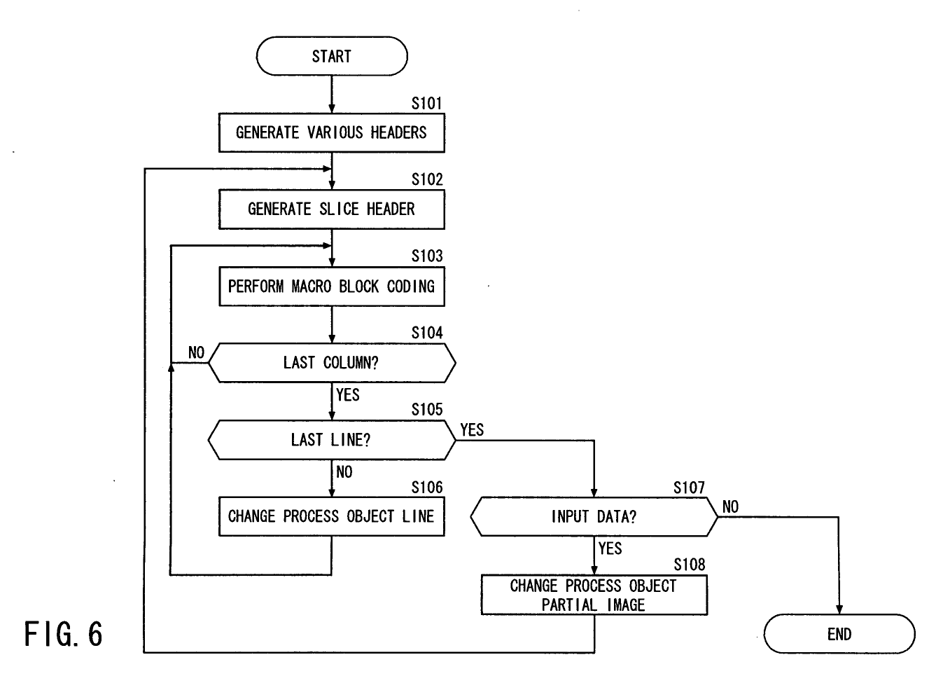

FIG. 6 illustrates another example of the coding processing in the first embodiment. Steps S101 to S108 in FIG. 6 are performed in the step S12 in FIG. 2 as same as the steps S101 to S108 in FIG. 5. The example of the coding processing illustrated in FIG. 6 is the same as the example of the coding processing illustrated in FIG. 5 except a point that the coding processing shifts not to the step S102 but to the step S103 after performing the step S106. In the example of the coding processing illustrated in FIG. 6, the slice headers are generated every time when the process object partial image is changed, and therefore, a data amount of the coded data is reduced compared to a case when the slice headers are generated every time when the process object line is changed (the example of the coding processing illustrated in FIG. 5).

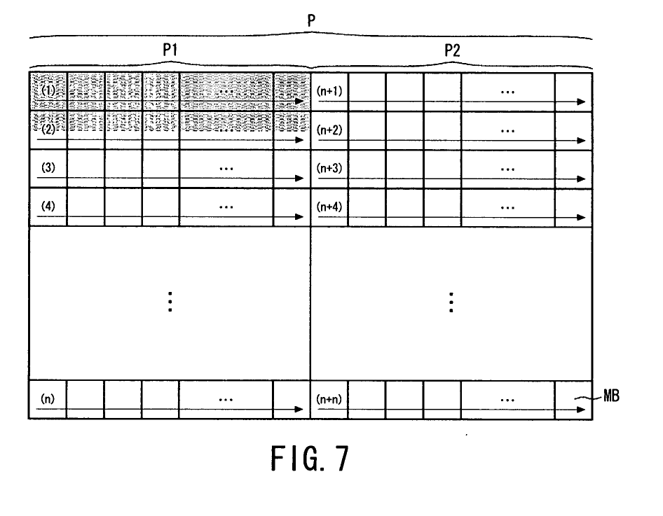

FIG. 7 illustrates a decoding processing sequence and a state of a cache memory (when the dividing number of image is two) when the coded data in the first embodiment is decoded. When the coded data (when the dividing number of image is two) in the first embodiment is decoded, at first, a decoding is sequentially performed from the macro block MB at a first column as for a first line (FIG. 7 (1)) of the partial image P1 of the reference image P. When the decoding of the macro block MB at a last column in the first line of the partial image P1 is completed, the decoding is sequentially performed from the macro block MB at a first column as for a second line (FIG. 7 (2)) of the partial image P1. After that, the macro blocks MB in a third line (FIG. 7 (3)), a fourth line (FIG. 7 (4)), . . . , an n-th line (FIG. 7 (n)) of the partial image P1 are sequentially decoded similarly.

When the decoding of the macro blocks MB in the n-th line of the partial image P1 is completed, the macro blocks MB at a first line (FIG. 7 (n+1)) of the partial image P2 of the reference image P are sequentially decoded. When the decoding of the macro block MB at a last column in the first line of the partial image P2 is completed, the decoding is sequentially performed from the macro block MB at a first column as for a second line (FIG. 7 (n+2)) of the partial image P2. After that, the macro blocks MB in a third line (FIG. 7 (n+3)), a fourth line (FIG. 7 (n+4)), . . . , an n-th line (FIG. 7 (n+n)) of the partial image P2 are sequentially decoded similarly.

It is assumed that a capacity of a cache memory of a video decoding device (processor) to decode the coded data is half of a horizontal size of the reference image P. Accordingly, the number of occurrence times of a load cache miss is reduced when the decoding of the macro blocks MB in the first line of the partial image P1 is completed and the processing shifts to the decoding of the macro blocks MB in the second line of the partial image P1, because a reference image data in a vicinity of the macro blocks MB in the second line of the partial image P1 (the data corresponding to a half-tone dot meshing portion in FIG. 7) exists in the cache memory.

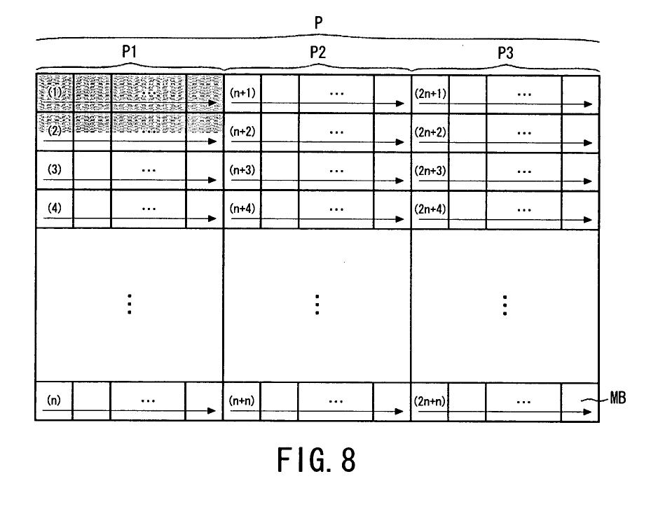

FIG. 8 illustrates the decoding processing sequence and the state of the cache memory (when the dividing number of image is three) when the coded data in the first embodiment is decoded. When the coded data (when the dividing number of image is three) in the first embodiment is decoded, at first, the decoding is sequentially performed from the macro block MB at a first column as for a first line (FIG. 8 (1)) of the partial image P1 of the reference image P. When the decoding of the macro block MB at a last column in the first line of the partial image P1 is completed, the decoding is sequentially performed from the macro block MB at a first column as for a second line (FIG. 8 (2)) of the partial image P1. After that, the macro blocks MB in a third line (FIG. 8 (3)), a fourth line (FIG. 8 (4)), . . . , an n-th line (FIG. 8 (n)) of the partial image P1 are sequentially decoded similarly.

When the decoding of the macro blocks MB in the n-th line of the partial image P1 is completed, the macro blocks MB in a first line (FIG. 8 (n+1)) of the partial image P2 of the reference image P are sequentially decoded. When the decoding of the macro block MB at a last column in the first line of the partial image P2 is completed, the decoding is sequentially performed from the macro block MB at a first column as for a second line (FIG. 8 (n+2)) of the partial image P2. After that, the macro blocks MB in a third line (FIG. 8 (n+3)), a fourth line (FIG. 8 (n+4)), . . . , an n-th line (FIG. 8 (n+n)) of the partial image P2 are sequentially decoded similarly.

When the decoding of the macro blocks MB in the n-th line of the partial image P2 is completed, the macro blocks MB in a first line (FIG. 8 (2n+1)) of the partial image P3 of the reference image P are sequentially decoded. When the decoding of the macro block MB at a last column in the first line of the partial image P3 is completed, the decoding is sequentially performed from the macro block MB at a first column as for a second line (FIG. 8 (2n+2)) of the partial image P3. After that, the macro blocks MB in a third line (FIG. 8 (2n+3)), a fourth line (FIG. 8 (2n+4)), . . . , an n-th line (FIG. 8 (2n+n)) of the partial image P3 are sequentially decoded similarly.

It is assumed that the capacity of the cache memory of the video decoding device (processor) is one third of the horizontal size of the reference image P. Accordingly, the number of occurrence times of the load cache miss is reduced when the decoding of the macro blocks MB in the first line of the partial image P1 is completed and the processing shifts to the decoding of the macro blocks MB in the second line of the partial image P1, because a reference image data in a vicinity of the macro blocks MB in the second line of the partial image P1 (the data corresponding to a half-tone dot meshing portion in FIG. 8) exists in the cache memory.

As stated above, in the first embodiment, it is possible to change the coding processing sequence at the coding unit 12 in accordance with the dividing number of image set by the image-dividing number setting unit 11, and therefore, it is possible to suppress the occurrence of the load cache miss even when the capacity of the cache memory used for the decoding of the coded data (a coding result of the coding unit 12) is not large enough relative to a resolution of the video.

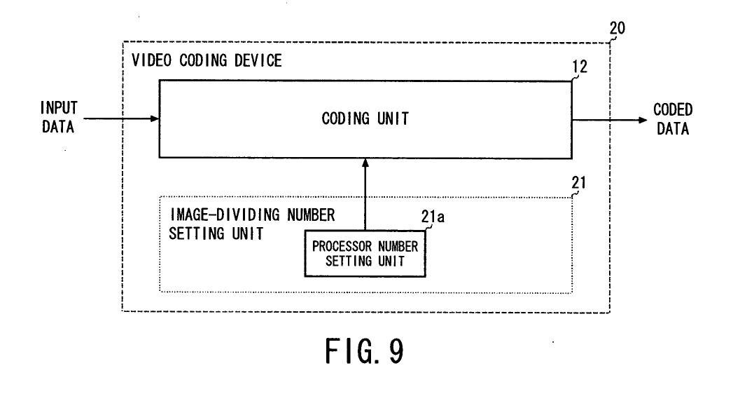

FIG. 9 illustrates a second embodiment. Incidentally, when the second embodiment is described, a detailed description is not given as for elements which are the same as the elements described in the first embodiment, and they are respectively identified by the same reference numerals as the ones used in the first embodiment.

A video coding device 20 of the second embodiment is constituted by replacing the image-dividing number setting unit 11 in the video coding device 10 of the first embodiment (FIG. 1) by an image-dividing number setting unit 21. The image-dividing number setting unit 21 is constituted by including a processor number setting unit 21a. The processor number setting unit 21a sets a number of processors constituting a video decoding device (not-illustrated) to decode a coded data generated by the video coding device 20 (the coding unit 12).

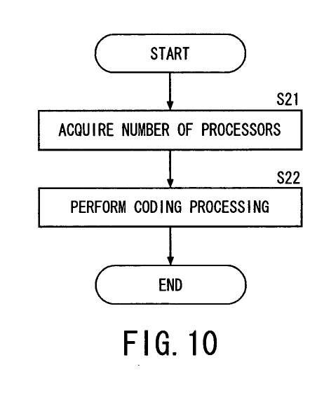

FIG. 10 illustrates an operation of the video coding device in the second embodiment. In the video coding device 20 having the constitution as stated above, the coding unit 12 acquires the number of processors held by the processor number setting unit 21a of the image-dividing number setting unit 21 as the dividing number of image in accordance with a reception of an input data by the video coding device 20 (step S21). The coding unit 12 divides the coding object image into the partial images with the same number as the dividing number of image, and performs the coding processing using the motion compensation on each of the partial images as same as in the first embodiment (step S22). The similar effect as the first embodiment may be obtained by the second embodiment as stated above.

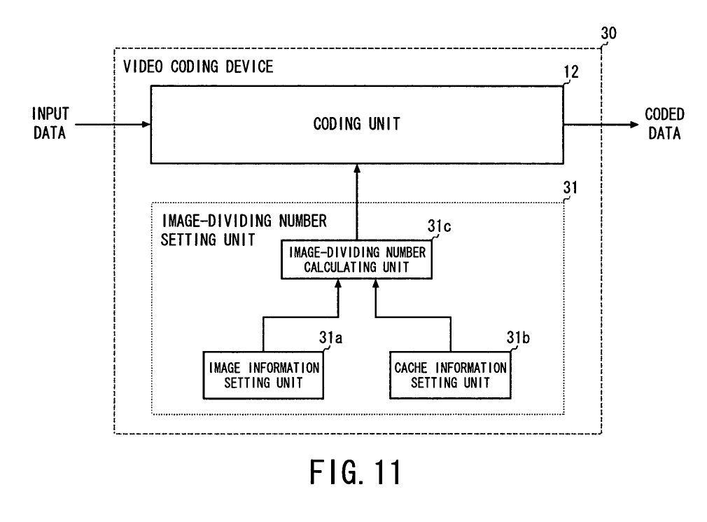

FIG. 11 illustrates a third embodiment. Incidentally, when the third embodiment is described, a detailed description is not given as for elements which are the same as the elements described in the first embodiment, and they are respectively identified by the same reference numerals as the ones used in the first embodiment.

A video coding device 30 of the third embodiment is constituted by replacing the image-dividing number setting unit 11 in the video coding device 10 of the first embodiment (FIG. 1) by an image-dividing number setting unit 31. The image-dividing number setting unit 31 is constituted by including an image information setting unit 31a, a cache information setting unit 31b, and an image-dividing number calculating unit 31c. The image information setting unit 31a sets information (image size, luminance and color difference format, macro block size, reference image number, and so on) relating to a coding object image. The cache information setting unit 31b sets information (capacity, mode, and so on) relating to a cache memory of a processor constituting a video decoding device (not-illustrated) to decode a coded data generated by the video coding device 30 (the coding unit 12).

The image-dividing number calculating unit 31c acquires the information held by the image information setting unit 31a and the cache information setting unit 31b, and calculates the dividing number of image based on the information acquired from the image information setting unit 31a and the cache information setting unit 31b. For example, the dividing number of image “divnum” calculated by the image-dividing number calculating unit 31c is represented by an expression (1) by using a ceiling function “ceiling( )”, an image horizontal size “hsize”, a macro block vertical size “mbvsize”, a reference image number “refnum”, and a cache size (capacity of cache memory) “csize”, when the luminance and color difference format is a “4:2:0” format.

divnum=ceiling((1.5×mbvsize×refnum×hsize)/csize) (1)

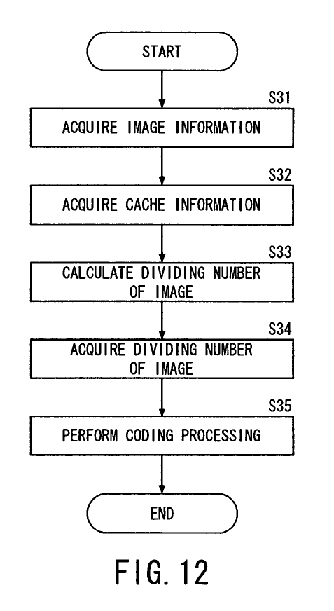

FIG. 12 illustrates an operation of the video coding device in the third embodiment. In the video coding device 30 having the constitution as stated above, the image-dividing number calculating unit 31c sequentially acquires the information held by the image information setting unit 31a and the information held by the cache information setting unit 31b in accordance with a reception of an input data by the video coding device 30 (steps S31 and S32). Next, the image-dividing number calculating unit 31c calculates the dividing number of image based on the information acquired from the image information setting unit 31a and the cache information setting unit 31b (step S33). The coding unit 12 then acquires the dividing number of image calculated by the image-dividing number calculating unit 31c of the image-dividing number setting unit 31 (step S34). After that, the coding unit 12 divides the coding object image into the partial images with the same number as the dividing number of image, and performs the coding processing using the motion compensation on each of the partial images as same as in the first embodiment (step S35). The similar effect as the first embodiment may be obtained by the third embodiment as stated above.

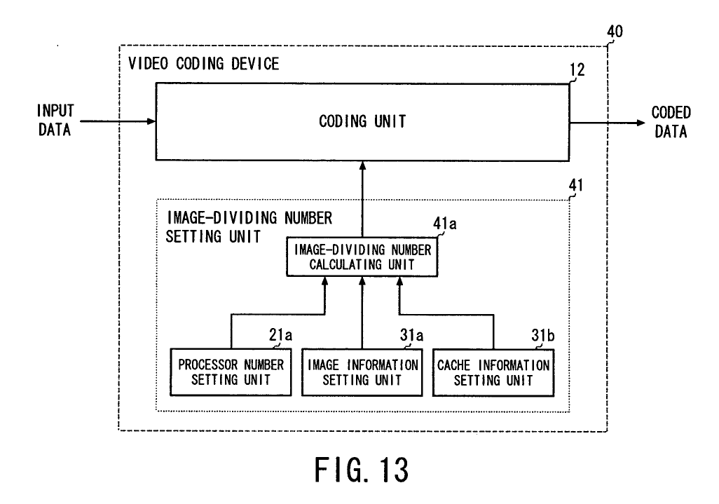

FIG. 13 illustrates a fourth embodiment. Incidentally, when the fourth embodiment is described, a detailed description is not given as for elements which are the same as the elements described in the first to third embodiments, and they are respectively identified by the same reference numerals as the ones used in the first to third embodiments.

A video coding device 40 of the fourth embodiment is constituted by replacing the image-dividing number setting unit 11 in the video coding device 10 of the first embodiment (FIG. 1) by an image-dividing number setting unit 41. The image-dividing number setting unit 41 is constituted by including the processor number setting unit 21a (the second embodiment (FIG. 9)), the image information setting unit 31a, the cache information setting unit 31b (the third embodiment (FIG. 11)), and an image-dividing number calculating unit 41a.

The image-dividing number calculating unit 41a acquires information held by the processor number setting unit 21a, the image information setting unit 31a and the cache information setting unit 31b, and calculates the dividing number of image based on the information acquired from the processor number setting unit 21a, the image information setting unit 31a, and the cache information setting unit 31b. For example, the dividing number of image “divnum” calculated by the image-dividing number calculating unit 41a is represented by an expression (2) by using the ceiling function “ceiling( )”, the image horizontal size “hsize”, the macro block vertical size “mbvsize”, the reference image number “refnum”, the cache size “csize”, and a processor number “pnum” when the luminance and color difference format is the “4:2:0” format.

divnum=ceiling((1.5×mbvsize×refnum×hsize/pnum)/csize)×pnum (2)

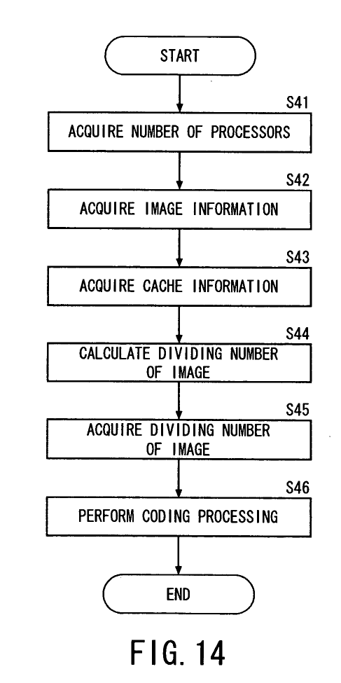

FIG. 14 illustrates an operation of the video coding device in the fourth embodiment. In the video coding device 40 having the constitution as stated above, the image-dividing number calculating unit 41a sequentially acquires the information held by the processor number setting unit 21a, the information held by the image information setting unit 31a, and the information held by the cache information setting unit 31b (steps S41, S42, and S43) according to a reception of an input data by the video coding device 40. Next, the image-dividing number calculating unit 41a calculates the dividing number of image based on the information acquired from the processor number setting unit 21a, the image information setting unit 31a, and the cache information setting unit 31b (step S44). The coding unit 12 then acquires the dividing number of image calculated by the image-dividing number calculating unit 41a of the image-dividing number setting unit 41 (step S45). After that, the coding unit 12 divides the coding object image into the partial images with the same number as the dividing number of image, and performs the coding processing using the motion compensation on each of the partial images as same as in the first embodiment (step S46). The similar effect as the first embodiment may be obtained by the fourth embodiment as stated above.

Incidentally, an example in which the image-dividing number calculating unit 31c acquires the information from the cache information setting unit 31b after acquiring the information from the image information setting unit 31a is described in the third embodiment (FIG. 12), but the invention is not limited to such embodiment. It goes without saying that the image-dividing number calculating unit 31c may acquire the information from the image information setting unit 31a after acquiring the information from the cache information setting unit 31b.

Similarly, an example in which the image-dividing number calculating unit 41a acquires the information from the image information setting unit 31a after acquiring the information from the processor number setting unit 21a, and acquires the information from the cache information setting unit 31b after acquiring the information from the image information setting unit 31a is described in the fourth embodiment (FIG. 14), but the invention is not limited to such embodiment. It goes without saying that the sequence in which the image-dividing number calculating unit 41a acquires the information from the processor number setting unit 21a, the image information setting unit 31a, and the cache information setting unit 31b may be changed.

A video coding standard such as MPEG-1, MPEG-2, MPEG-4, H.264/AVC may applies to aforementioned embodiment.

According to the embodiment, for example, the partial images may include a first partial image and a second partial image. A coded data generated by the coding processing has a structure in which the coded data of the second partial image follows after the coded data of the first partial image. The coding unit performs the coding processing on the second partial image after performing the coding processing on the first partial image.

According to the embodiment, for example, the image-dividing number setting unit sets a number of processors used when decoding a coding result of the coding unit as the dividing number of image.

According to the embodiment, for example, the image-dividing number setting unit includes an image information setting unit, a cache information setting unit, and an image-dividing number calculating unit. The image information setting unit sets information relating to the coding object image (an image information setting operation). The cache information setting unit sets information relating to a cache memory used when decoding a coding result of the coding unit (a cache information setting operation). The image-dividing number calculating unit calculates the dividing number of image based on the information set by the image information setting unit and the cache information setting unit (an image-dividing number calculating operation).

According to the embodiment, for example, the image-dividing number setting unit includes a processor number setting unit, an image information setting unit, a cache information setting unit, and an image-dividing number calculating unit. The processor number setting unit sets a number of processors used when decoding a coding result of the coding unit (a processor number setting operation). The image information setting unit sets information relating to the coding object image (an image information setting operation). The cache information setting unit sets information relating to a cache memory used when decoding the coding result of the coding unit (a cache information setting operation). The image-dividing number calculating unit calculates the dividing number of image based on the information set by the processor number setting unit, the image information setting unit, and the cache information setting unit (an image-dividing number calculating operation).

In the video coding device as stated above, it is possible to change a coding processing sequence at the coding unit in accordance with the number of images to be divided set by the image-dividing number setting unit, and therefore, it is possible to suppress the occurrence of the load cache miss even when the capacity of the cache memory used for the decoding of the coding result of the coding unit is not large enough relative to the resolution of the video.

According to the embodiment, it is possible to suppress an occurrence of a load cache miss when a coded data is decoded without increasing a capacity of a cache memory even when a resolution of a video is high.

The embodiment is useful to be applied for a video coding device performing a coding processing using a motion compensation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A video coding device comprising:
an image-dividing number setting unit setting a dividing number of image; and
a coding unit dividing a coding object image constituting a video into partial images with the similar number to the dividing number of image, and performing a coding processing using a motion compensation on each of the partial images.

2. The video coding device according to claim 1, wherein
the image-dividing number setting unit sets a number of processors used when decoding a coding result of the coding unit as the dividing number of image.

3. The video coding device according to claim 1, wherein
the image-dividing number setting unit includes:
an image information setting unit setting information relating to the coding object image;
a cache information setting unit setting information relating to a cache memory used when decoding a coding result of the coding unit; and
an image-dividing number calculating unit calculating the dividing number of image based on the information set by the image information setting unit and the cache information setting unit.

4. The video coding device according to claim 1, wherein
the image-dividing number setting unit includes:
a processor number setting unit setting a number of processors used when decoding a coding result of the coding unit;
an image information setting unit setting information relating to the coding object image;
a cache information setting unit setting information relating to a cache memory used when decoding the coding result of the coding unit; and
an image-dividing number calculating unit calculating the dividing number of image based on the information set by the processor number setting unit, the image information setting unit, and the cache information setting unit.

5. The video coding device according to claim 1, wherein
the partial images include a first partial image and a second partial image, and wherein
a coded data generated by the coding processing has a structure in which the coded data of the second partial image follows after the coded data of the first partial image.

6. The video coding device according to claim 1, wherein
the partial images include a first partial image and a second partial image, and wherein
the coding unit performs the coding processing on the second partial image after performing the coding processing on the first partial image.

7. A video coding method comprising:
performing an image-dividing number setting operation setting a dividing number of image; and
performing a coding operation dividing a coding object image constituting a video into partial images with the similar number to the dividing number of image, and performing a coding processing using a motion compensation on each of the partial images.

8. The video coding method according to claim 7, wherein
a number of processors used when decoding a coding result of the coding operation is set as the dividing number of image in the image-dividing number setting operation.

9. The video coding method according to claim 7, wherein
the image-dividing number setting operation includes:
an image information setting operation setting information relating to the coding object image;
a cache information setting operation setting information relating to a cache memory used when decoding a coding result of the coding operation; and
an image-dividing number calculating operation calculating the dividing number of image based on the information set by the image-information setting operation and the cache information setting operation.

10. The video coding method according to claim 7, wherein
the image-dividing number setting operation includes:
a processor number setting operation setting a number of processors used when decoding a coding result of the coding operation;
an image information setting operation setting information relating to the coding object image;
a cache information setting operation setting information relating to a cache memory used when decoding the coding result of the coding operation; and
an image-dividing number calculating operation calculating the dividing number of image based on the information set by the processor number setting operation, the image information setting operation, and the cache information setting operation.

11. The video coding method according to claim 7, wherein
the partial images include a first partial image and a second partial image, and wherein
a coded data generated by the coding operation has a structure in which the coded data of the second partial image follows after the coded data of the first partial image.

12. The video coding method according to claim 7, wherein
the partial images include a first partial image and a second partial image, and wherein
the coding processing on the second partial image is performed after the coding processing on the first partial image is performed in the coding operation.
